(19) United States
(12) Patent Application Publication
(10) Pub. No.: US 2018/0253576 A1
(43) Pub. Date: Sep. 6, 2018

(54) METHOD AND SYSTEM FOR CAPTURING 2-D BARCODES

(71) Applicant: VERIFIED INTERNATIONAL PTY LTD, Notting Hill, Victoria (AU)

(72) Inventor: Glenn Talbot, Notting Hill, Victoria (AU)

(21) Appl. No.: 15/760,740

(22) PCT Filed: Sep. 16, 2016
(86) PCT No.: PCT/AU2016/000321

§ 371 Date: Mar. 16, 2018

(30) Foreign Application Priority Data
Sep. 16, 2015 (AU) 2015903765

(51) Int. Cl. G06K 7/10; G06K 7/14; G07C 1/10

(52) U.S. Cl. CPC G06K 7/10722; G06K 7/1417; G06K 2007/10524; G07C 1/10; G06K 7/10881

(57) ABSTRACT

The invention relates to a computer-implemented method for capturing a 2-D barcode using a portable digital device including a browser and a digital camera. The method comprising accessing, via the browser, a web page configured to enable a user to capture 2-D barcodes, and downloading a software application from the web page. The software application, via the browser, prompts the user to take a photograph of a 2-D barcode, and then launches the digital camera to take a photograph capturing the 2-D barcode. The software application identifies the barcode, or transmits the photograph to a remote server to decode the barcode, and opens a further web page associated with the 2-D barcode in the browser. Of particular note, the barcode may be used to record attendance and time of attendance at the site via the browser. The invention has application to monitoring maintenance works and site attendance by maintenance personnel.

### FIELD

The invention relates to the field of maintenance, asset verification and site attendance/registration. Aspects of the invention relate to methods and systems for capturing 2-D barcodes using portable digital devices. The invention has many potential applications and is particularly suitable for building and/or onsite ‘field’ maintenance and site attendance; however, it should be appreciated that the invention is not limited to that use only.

### INCORPORATION BY REFERENCE

This application claims priority from Australian provisional application no 2015903765, the entire contents of which are hereby incorporated by reference.

### BACKGROUND

A number of problems exist in respect of verifying that maintenance and/or onsite visits are actually conducted. Site owners and operators have a number of liability issues that require attention. For example, a building owner may need to maintain air conditioning system(s), and typically is required by laws and regulations to periodically check the working order of fire and other safety systems. Such laws and regulations also frequently state that a physical record or logbook must be kept recording attendance and confirming working order or otherwise reporting defects. Another example is that of the required control of external contractors with regard to OH&S and liability associated with works undertaken on their premises. Site owners have an obligation to ensure a safe workplace for all persons entering their premises, not just their employees. The proper OH&S/Pennit/registration/insurance documentation must be utilised and authorised before any work is performed.

Accordingly, site owners and operators often engage third parties to provide maintenance contractors in order to undertake the work necessary to fulfil their obligations. It is then up to the maintenance contractor to ensure that the agreed work is undertaken. For example, in accordance with a maintenance contract, it is typically necessary for one or more technicians to visit a number of buildings at regular and agreed intervals. A technician may be provided with a list of buildings to visit each day, but it may be difficult to verify that the technician has in fact visited each site. Also, the same site may need to be visited at different intervals for different maintenance tasks. For example, a car park may need to have certain fire prevention systems checked every three (3) months and, separately, ventilation systems checked every six (6) months with each check being associated with a different physical record.

A further problem exists in respect of the reporting of maintenance work undertaken. As noted above, a site owner or operator typically requires a physical documented record of maintenance work so that it can establish that it has fulfilled its liability commitments. It is common for these records to be filled in by-hand and (again) there is no confirmation that the technician has in fact visited the agreed location. Such records can be, and sometimes are, filled in without attendance taking place. Summaries of maintenance work are also typically provided before payment of invoices is authorised, however frequently these comprise tables or spreadsheets indicating 100% attendance which, in practice, is often uncommon. Accordingly, site owners and operators frequently pay for 100% attendance, but not actually receive that level of service.

Given that maintenance companies often have a large number of technicians with many tasks, there is also the need to provide each technician with a low-cost and relatively simple method to capture information relating to the execution of the required tasks.

Other problems which are typical in the maintenance and asset verification industry include:
Clients may have no visibility of services delivered.
Clients may have no knowledge of when a contractor arrives and departs a site/service.
Technicians may not have specific client and/or asset information on hand in the field to determine specifications/tasks to be performed.
Technicians may not have up to date information of client contract specifications, tasks and/or requirements.
There may be a significant time lag between when a defect is identified and when it is reported.
Reporting of maintenance information may be inconsistent across contractors.
The cost burden for maintenance activities for dedicated electronic field capture devices may be uneconomical.
It is difficult for clients to mandate the use of specific software and hardware for field maintenance across multiple contractors.
Clients may have no specific on site data attached to plant/equipment.
Technicians may struggle with complicated electronic field devices and require regular training.
Some records may be paper based and not electronically reportable.
Records may not be in a format that is able to be easily stored and reported.
It is often a requirement to control the induction and permit process and to make this information available to all parties before any work is carried out.

There is a need for a system and/or process which allows deployment of a common platform to gather information, whether there is one location or hundreds of locations, one service provider or many service providers.

There is also a need for a system and/or process which allows for confirmation of attendance, confirmation of duration of the task, provision of real-time or near real-time updating of system/asset status, automatic or at least prompt notification of system defects and problems. The information, data and system needs to be independent of contractors thereby providing the ability to have many contractors using a common system, as well as having the ability to change contractors at any time.

It is an object of the invention to substantially overcome or at least ameliorate one or more of the disadvantages of the prior art or at least provide a useful alternative.

### SUMMARY

In an aspect of the present invention, there is provided a computer-implemented method for verifying attendance using a portable digital device including a browser, the method comprising:
attending a site with the portable digital device;
capturing, with the portable digital device, a first barcode affixed proximate the site or on a physical record; and
recording, using the personal digital device, attendance and time of attendance at the site via the browser.

The method may further comprise:
capturing a second barcode on a physical record, with the portable digital device; and
recording attendance and time of attendance at the site with the physical record via the browser.

The portable digital device may further include a GPS receiver, and the method may further comprise recording geographic location via the browser.

The first barcode is associated with a specific web page containing a task list, and the method may comprise displaying the task list, via the browser, for the user to complete.

The method according to any one of claims 2 to 5, wherein the portable digital device further comprises a barcode reader, and the method comprises capturing the first barcode and/or the second barcode using the barcode reader.

In a further aspect of the present invention, there is provided a computer-implemented method for capturing a 2-D barcode comprising:
providing a web page;
upon receiving a request to access the web page from a user using a browser on a portable digital device, causing a software application to be downloaded to the portable digital device, the software application configured to prompt the user to take a photograph of the 2-D barcode using a digital camera of the portable digital device;
receiving a photograph of the 2-D barcode; and
identifying a site or physical record associated with the 2-D barcode.

In an aspect of the present invention, there is provided a computer-implemented method for capturing a 2-D barcode using a portable digital device including a browser and a digital camera, the method comprising:
accessing, via the browser, a web page configured to enable a user to capture 2-D barcodes,
the portable digital device downloading a software application from the web page;
the software application, via the browser, prompting the user to take a photograph of a 2-D barcode;
the software application launching the digital camera;
taking a photograph capturing the 2-D barcode, using the digital camera; and
the software application opening a further web page associated with the 2-D barcode in the browser.

This aspect of the present invention therefore provides advantages over existing methods of capturing a 2-D barcode using a portable digital device, which require the user to download or otherwise have installed on the device, a separate or standalone software application (or app). The requirement to download and install an application can be onerous, and creates additional steps and complexity, particularly where a standardised or uniform process is sought to be achieved across multiple users. It also requires additional setup and configuration steps, and the user may need to have specific knowledge regarding the functioning of the app itself. In addition, the use of separate or standalone applications may also require the constant upgrading of the application's software, for example to maintain compatibility with various operating system upgrades. This aspect of the present invention may be combined with other aspects to also provide advantages in verifying attendance.

In a further aspect of the present invention, there is provided a system for verifying attendance, comprising:
a first barcode affixed proximate a site or on a physical record; and
a portable digital device including a browser, configured to:
   capture the first barcode with the portable digital device upon a user's attendance at the site; and
   permit the user to record attendance and time of attendance at the site via the browser.

In a further aspect of the present invention, there is provided a system for verifying attendance comprising:
a memory; and
a processor configured to perform the method of any of the other aspects of the present invention.

In another aspect of the present invention, there is provided a method or system for verifying attendance, comprising:
a barcode affixed proximate a site or on a physical record; and
a portable digital device including a browser, barcode reader and hardware configured to scan the barcode,
wherein a user:
attends the site with the portable digital device;
captures the barcode with the portable digital device; and
records attendance and time of attendance at the site via the browser.

In another aspect of the present invention, there is provided a method or system for verifying attendance, comprising:
a first barcode affixed proximate a site;
a second barcode on a physical record; and
a portable digital device including a browser, barcode reader and hardware configured to scan the barcodes,
wherein a user:
attends the site with the portable digital device and the physical record;
captures the first barcode and the second barcode with the portable digital device; and
records attendance and time of attendance at the site with the physical record via the browser.

In a further aspect of the present invention, there is provided a method or system for verifying attendance, comprising:
a barcode affixed proximate a site or on a physical record; and
a portable digital device including a browser, GPS receiver, barcode reader and hardware configured to scan the barcodes,
wherein a user:
attends the site with the portable digital device;
captures the barcode with the portable digital device; and
records attendance, time of attendance and geographic location via the browser.

In a yet another aspect of the present invention, there is provided a method or system for verifying attendance, comprising:
a first barcode affixed proximate a site;
a second barcode on a physical record; and
a portable digital device including a browser, GPS receiver, barcode reader and hardware configured to scan the barcodes,
wherein a user:
attends the site with the portable digital device and the physical record;
captures the first barcode and the second barcode with the portable digital device; and
records attendance, time of attendance and geographic location with the physical record via the browser.

In another aspect of the present invention, there is provided a method or system for verifying attendance, comprising:
a barcode associated with a specific web page affixed proximate a site or on a physical record; and
a portable digital device including a browser, GPS receiver, barcode reader and hardware configured to scan the barcodes,
wherein a user:
attends the site with the portable digital device;
captures the barcode with the portable digital device and accesses the associated web page via the browser;
records attendance, time of attendance and geographic location via the browser;
logs in to the associated web page which contains a task list of items to be completed by the user; and,
the user completes the task list.

In further related aspects of the present invention, the user may record, via the browser, information separate from or in addition to attendance, time of attendance and geographic location such as, for example, any work undertaken at the location. The user may capture a barcode and, via the browser on the portable digital device, re-submit attendance at the site to record cessation of attendance at the site and/or log out of a web page associated with the barcode. The physical record may be a maintenance logbook. The barcode(s) may be 2-D barcode(s). The barcode(s) may be ‘affixed’ by being printed directly on a physical record. Information recorded by the user via the browser may be transmitted to a database. The database may be configured to generate reports of, for example, attendance or non-attendance at a site based on the information recorded (or not recorded) by the user.

In another aspect of the present invention, there is provided a method or system for capturing a 2-D barcode, comprising:
a portable digital device including a browser and a digital camera; and
a web page configured to enable a user to capture 2-D barcodes,
wherein a user accesses the web page via the browser;
the portable digital device downloads a software application from the web page;
the software application, via the browser, prompts the user to take a photo of a 2-D barcode;
the software application launches the digital camera;
the user takes a photo capturing the 2-D barcode; and
the software application opens any web page associated with the 2-D barcode in the browser.

A detailed description of one or more embodiments of the invention is provided below, along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents.

For the purpose of example, numerous specific details are set forth in the following description in order to provide a thorough understanding of the present invention. The present invention may be practiced according to the claims without some or all of these specific details. For the purposes of clarity, technical material that is known in the technical fields related to the invention has not been described in detail so that the present invention is not unnecessarily obscured.

### BRIEF DESCRIPTION OF THE DRAWINGS

Preferred embodiments of the invention will now be described with reference to the accompanying drawings wherein:

FIG. 1 depicts a flowchart depicting a method for verifying attendance in accordance with an embodiment;

FIG. 2 depicts an example of a 2-D barcode; and

FIG. 3 depicts a flowchart of an application of a preferred embodiment.

FIG. 4 is an example screen of a smartphone depicting a display of a browser prompting a user to take a photo of a 2-D barcode in accordance with a preferred embodiment.

### DESCRIPTION OF EMBODIMENTS

In accordance with an embodiment, a first barcode is provided at or near a site where maintenance is to be performed. A second barcode is provided on a physical maintenance record. A portable digital device including a browser, barcode reader and hardware configured to scan the barcodes is also provided. A user, upon attending the site with the portable digital device, scans the first barcode and the second barcode, enabling the user to capture the barcodes. Via the browser, the user records attendance at the location with the physical maintenance record at a particular time.

The barcodes may be a 2-D barcode (or matrix code), a linear barcode or another form of indicia recordable with a portable digital device. Preferably the barcode is a 2-D barcode. An example of a 2-D barcode is a QR Code depicted in FIG. 2 (see, for example, U.S. Pat. No. 5,726,435—“QR Code” is a registered trademark of Denso Wave Incorporated).

The portable digital device may be a smartphone, personal digital assistant (PDA), tablet or laptop, preferably with messaging capability. The browser is a software application for retrieving, presenting and traversing information. The barcode reader is a software application adapted to the hardware for scanning the barcode. The barcode reader may be included in the browser (or vice versa). The hardware for scanning the barcode may be a digital camera, laser scanner or any other barcode scanning hardware suitable for a portable digital device. As an example, in use, a 2-D barcode may be scanned by a smartphone by means of a digital camera and a corresponding barcode reader. The portable digital device may also include a GPS receiver and the user may also record the geographical location of attendance via the browser. More specific details are described below.

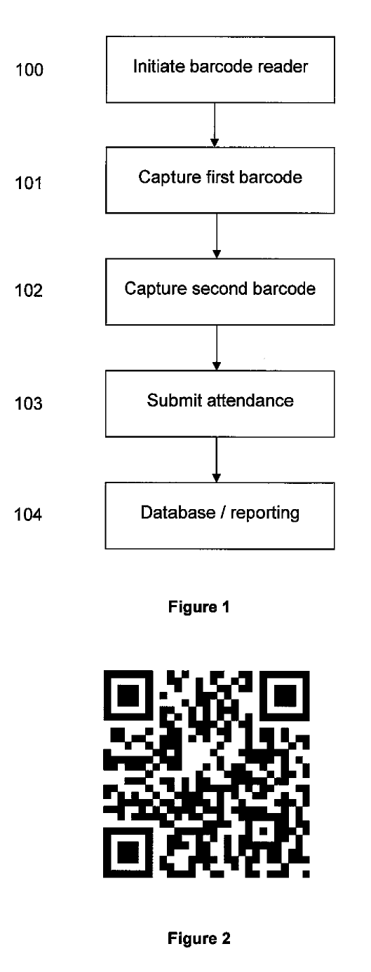

Referring to FIG. 1, there is depicted a flowchart depicting a method for verifying attendance in accordance with an embodiment. A user attending a site initiates a barcode reader 100 on a portable digital device. The user then captures a first barcode 102 affixed proximate to the site. The user can capture a second barcode 102 on a physical record associated with the site, such as, for example a maintenance logbook. Step 102 can be performed before 101, but it is nonetheless preferred that they are performed in sequence. The user, via the browser on the portable digital device, then submits attendance and time of attendance 103 at the site with the physical record. The information submitted in 103 is transmitted to a database 104 that may be used for reporting.

This method for verifying attendance may utilise existing field recording systems (physical records), for example, contractor logbooks, but also enable accurate and reliable verification of attendance with minimal capital expenditure. In a preferred embodiment, unique QR codes are allocated and affixed to a site and an existing logbook (physical record) associated with the site. A barcode can be affixed to a site by printing the barcode on an adhesive label (sticker) or, more preferably, the barcode is printed on a durable piece of plastic with an adhesive backing, and affixed to a location at the site preferably where maintenance is to be performed, for example, on or adjacent to a Fire Indicator Panel (FIP). A barcode can be affixed to a physical record again by printing the barcode on an adhesive label (sticker) and affixing it directly to the physical record. A barcode may also be is printed directly on the physical record once the method/system has been established.

The submission of time and attendance to a database may take the form of a CSV data file. The results may be uploaded directly into a client management system. This may facilitate close out of task work orders in client systems and therefore validate the invoice approval process. This may also enable automated reporting of non-attendance by comparison against requested schedules of attendance.

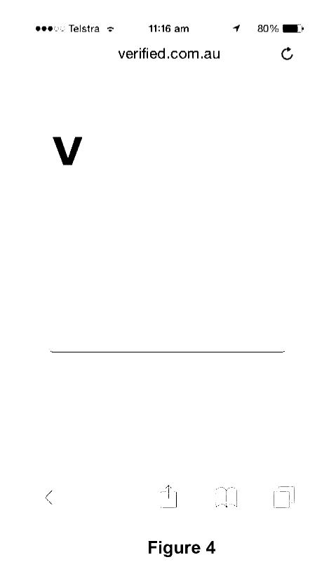

Of particular note, in accordance with an embodiment and aspect of the invention, there is provided a specific method of enabling a user to capture a 2-D barcode. A user accesses the web page via the browser on the device. The device downloads a software application from the web page. The software application, via the browser, prompts the user to take a photo of a 2-D barcode as seen in the example in FIG. 4. The software application launches the digital camera. The user takes a photo capturing the 2-D barcode. The software application opens any web page associated with the 2-D barcode in the browser.

Accordingly, the requirement to install a third party software application to capture 2-D barcodes is redundant in view of the methods and systems described. The downloading of an application when a specific web page is opened, allows full functionality of 2-D barcode web re-direction.

A user can simply open a web page and the read, decode, and redirect actions are all seamlessly downloaded in a small script library onto the local device. The web page provides a button to launch the local camera to take a photo of the 2-D barcode.

Once the 2-D barcode photo is captured the program script will decode the 2-D barcode and open the required web address that is embedded in the 2-D barcode. This web page can provide web forms via HTML 5, providing full interaction and data management.

As an alternative, the software application may transmit the photograph to a remote server (e.g. the server hosting the web page). Upon receiving the photograph, the server can analyse it to decode the 2-D barcode. This means that the/software application running on the web page can be smaller, as it is not necessary to include program instructions for decoding the barcode.

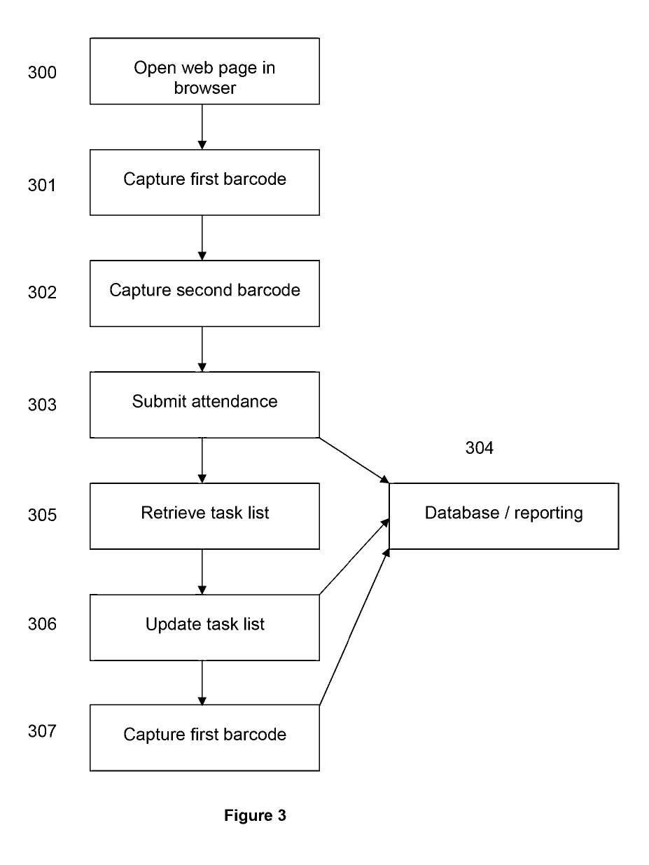

Referring to FIG. 3, a user attending a site opens a web page configured to enable a user to capture 2-D barcode in the browser 300 on a portable digital device. Specifically, the device downloads a software application from the web page. The software application, via the browser, prompts the user to take a photo of a 2-D barcode. The software application launches the digital camera. The user takes a photo capturing a first barcode 301 affixed proximate to the site. The user, following a similar prompt, also captures a second barcode 302 on a physical record associated with the site, such as, for example a maintenance logbook. Step 302 can be performed before 301, but it is nonetheless preferred that they are performed in sequence. The user, via the browser on the portable digital device, then submits attendance and time of attendance at the site with the physical record. The information submitted in 303 is transmitted to a database 304 that may be used for reporting.

Initial attendance having been verified, a task list 305 is able to be obtained, retrieved and/or received which may include up to date information of, for example, client contract specifications, tasks to be performed, tasks performed previously and/or which have been performed at the site and/or any other information relative to location, history, specifications and/or work performed or to be performed. The barcodes and/or information retrieved may also include information related to, for example, plant information, installation dates, service regime, client contract criteria and/or any other information which may be of use to a user. The browser may presents the user with a task list 305 comprising a number of questions and/or information fields which may be completed.

Once the user has completed the work to be performed at the site, the user updates the task list 306 (for example, by answering set questions). In this manner, an updated record of maintenance is obtained. This updated information is then transmitted or otherwise able to be captured in database 304. The user may then capture the first barcode 307 affixed proximate to the site and, via the browser on the portable digital device, re-submit attendance at the site to database 304 by way of confirmation that the required activity has been completed.

The updated information received by database 304 may be docketed, creating a record of the maintenance reported. Preferably the standard communication link relating to the portable digital device may be used. Alternatively, the information may be stored on the portable digital device, and later connected and downloaded in a suitable manner. Preferably the browser supports HTML5 and, if an internet or other network connection is not available, the information is cached until such a connection becomes available. In any case, it is preferred that a centralised database is used to store this information. The centralised database may also provide a web server for real-time or near real-time client access and automatic record and client reporting. For example, defect notification to the may be automated and immediate as a problem is identified at the site. Outputs and reports may take the following forms:
CSV data file or results for upload into client management system. This can facilitate close out of task work orders in client systems and therefore the invoice approval process.
Web portal reporting of service outcomes
Automated notification of defects and test failures via email to client representatives
Exception reporting: tests not completed, test outside tolerance, GPS confirmation—not matching database
Automated reporting
Reading, capture and reporting of data from test sheet photographs.

In the foregoing example of an application of a preferred embodiment described with reference to FIG. 3, the user only needs to attend the site with a portable digital device including a browser and a digital camera of the kind that many people routinely carry wherever they go. No specific software application may need to be downloaded. No settings on the device may need to be adjusted. The user just turns up to the site with a portable digital device of the kind that they would normally carry in any event.

In essence, embodiments of the present invention stem from the realization that the downloading of an application when a specific web page is opened may allow full functionality of 2-D barcode web re-direction.

Advantages provided by the present invention comprise one or any combination of the following:
It is relatively simple to operate.
May work across various smartphone platforms.
Enables a single common platform for multiple disparate users.
System and data are controlled by the operator of the web page.

Referring again to the task list retrieved 305 and updated 306 per FIG. 3, a task list can be deployed using one or a combination of pages, on multiple platforms common in the marketplace today. Examples of the software programs comprise, without limitation:
Google Android Operating System
Java2ME (Micro Edition)
Google XZing 2D barcode decode library
Windows Mobile
Apple iOS
Object C
Interface builder
COCOA
Blackberry enterprise SDK
Nokia Symbian OS
QR Code libraries

By utilizing a portable digital device which has a built in digital camera and related software, the task list may be configured to display and capture relevant information from the barcode the client wants to capture.

In preferred forms of this embodiment, the task list displays a data capture form associated with the site and may record one or more of:
Time and date—initial scan time in, submit record—time out
Work order or purchase order number assigned to the task being undertaken
Which service frequency was performed
Was it completed satisfactorily
Were there any issues
GPS notification of location against database address—exception reports
Photograph taken of on site record
Photograph of problem/defect/issues at site

In a further embodiment, a method or system for verifying attendance comprises a user attending a site with a portable digital device. A barcode associated with a specific web page is affixed proximate the site or on a physical record. The portable digital device includes a browser, GPS receiver, barcode reader and hardware configured to scan the barcodes. The user captures the barcode with the portable digital device and accesses the associated web page via the browser. The user records attendance, time of attendance and geographic location via the browser. The user logs in to the associated web page which contains a task list of items to be completed by the user. The user then completes the task list.

It is preferred that the login has been set up in advance and ensures access by approved users only. The task list may comprise a one or more web pages. The task list may include a preliminary signing/OH&S/permit process for the task the user is to perform. On exit the user submits the information via the browser and captures the barcode to record leaving the site.

This further embodiment allows site owners/operators to manage attendance at the site by contractors. Site owners/operators currently struggle with managing multiple entries and the required OH&S responsibilities: Who is on site? What are they doing? Is the right information in place? What is the output of the task? An alternate description of an aspect of this embodiment is as follows:

1. A 2D barcode is produced that is unique and references a specific web page.

2. The barcode is adhered to a site or maintenance logbook on site. It may also be pre-printed onto a maintenance logbook.

3. The user captures the barcode to take them to the relevant associated web page. This time and date stamps the transaction as well as locates them where a GPS receiver is operational.

4. The user then logs in to the web page. This then brings them to the a task list of the services they are to perform. This registration/login process has been previously set up and ensures access by approved persons only.

5. The web page takes them through the relevant signing/OH&S/permit process for the task(s) they are to perform.

6. The web page then provides them with a form to capture the relevant task/maintenance information.

7. On exit the user submits the information via the browser and captures the barcode to record leaving the site

There are a number of alternatives offered by the invention, including:

A. The application can be used for any field based attendance data capture requirement, not just for maintenance and assets. For example it could be used to manage transient objects.

B. The barcode may be displayed via an LCD display, which can also record and/or update information from the user's mobile phone and/or from the central record store

In essence, embodiments of the present invention stem from the realization that a combination of a barcode (such as, for example, a 2D or matrix barcode), portable digital device and browser may be used to capture and provide a record of field service, asset and/or maintenance information. In other words, by placing barcodes on field assets, plant, buildings, individual assets, structures, and by using a browser, asset, work related or any other information in the field can be captured. The browser may also capture specific status information that is keyed into the device by the maintenance technician/service provider as a record of work performed. This information may be transferred via the Internet, into a database reporting tool that provides service information back to the nominated party.

Advantages provided by the present invention comprise one or any combination of the following:
Confirms onsite attendance.
Confirms onsite delivery.
No or minimal capital costs for the maintenance/service provider and/or site owner/operator.
It is relatively simple to operate in the field.
Enables user to have or retrieve up to date information of client contract specifications, tasks and/or requirements relative to location or work to be performed.
The barcode may be used to hold asset and maintenance information in the field.
May work on common smartphone platform.
Low costs transaction model.
Maintenance/service provider independent.
Track time and date of delivery.
Real-time or near real-time reporting.
Specifies the format in which data is collected and in doing so standardises such data collection.
Updated information has timestamp which provides additional information.
Single platform for multiple providers.
System and data are controlled by the owner.
Contractor independent.
Can be deployed across many contractors and locations.
Same system can be used for many different services and/or assets.
Ensures OH&S and permit policies are controlled.

The invention can also be integrated with accounting or payment systems, so that invoices received from contractors can be cross-checked with the maintenance records and times of attendance recorded using the present invention. Inconsistencies between invoices and attendance records can be flagged, to allow further review by accounts staff or to prompt the contractor to provide additional information justifying the invoice.

Where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Throughout this specification and the claims which follow, unless the context requires otherwise, the word “comprise”, and variations such as “comprises” and “comprising”, will be understood to imply the inclusion of a stated integer or step or group of integers or steps, but not the exclusion of any other integer or step or group of integers or steps.

The reference in this specification to any prior publication (or information derived from it), or to any matter which is known is not, and should not be taken as an acknowledgment or admission or any form of suggestion that that prior publication (or information derived from it) or known matter forms part of the common general knowledge in the field of endeavour to which this specification relates.

1. A computer-implemented method for capturing a 2-D barcode using a portable digital device including a browser and a digital camera, the method comprising:
accessing, via the browser, a web page configured to enable a user to capture 2-D barcodes,
the portable digital device downloading a software application from the web page;
the software application, via the browser, prompting the user to take a photograph of a 2-D barcode;
the software application launching the digital camera;
taking a photograph capturing the 2-D barcode, using the digital camera; and
the software application opening a further web page associated with the 2-D barcode in the browser.

2. A computer-implemented method for verifying attendance using a portable digital device including a browser, the method comprising:
attending a site with the portable digital device;
capturing, with the portable digital device, a first barcode affixed proximate the site or on a physical record; and
recording, using the personal digital device, attendance and time of attendance at the site via the browser.

3. The method according to claim 2, further comprising:
capturing a second barcode on a physical record, with the portable digital device; and
recording attendance and time of attendance at the site with the physical record via the browser.

4. The method or system according to claim 2, wherein the portable digital device further includes a GPS receiver, the method further comprising:
recording geographic location via the browser.

5. The method according to claim 2, wherein the first barcode is associated with a specific web page containing a task list, the method comprising:
displaying the task list for the user to complete.

6. The method according to claim 2, wherein the portable digital device further comprises a barcode reader, and the method comprises capturing the first barcode and/or the second barcode using the barcode reader.

7. The method according to claim 2, wherein the portable digital device further comprises a digital camera, and the method comprises capturing the first barcode and/or the second barcode using the digital camera.

8. The method according to claim 7, wherein the method comprises capturing the first barcode and/or the second barcode.

9. A computer-implemented method for capturing a 2-D barcode comprising:
providing a web page;
upon receiving a request to access the web page from a user using a browser on a portable digital device, causing a software application to be downloaded to the portable digital device, the software application configured to prompt the user to take a photograph of the 2-D barcode using a digital camera of the portable digital device;
receiving a photograph of the 2-D barcode; and
identifying a site or physical record associated with the 2-D barcode.

10. A system for verifying attendance, comprising:
a first barcode affixed proximate a site or on a physical record; and
a portable digital device including a browser, configured to:
capture the first barcode with the portable digital device upon a user's attendance at the site; and
permit the user to record attendance and time of attendance at the site via the browser.

11. A system for capturing a 2-D barcode comprising:
a portable digital device including a processor and a digital camera,
wherein the processor is configured to perform the method of claim 1.

12. A system for verifying attendance comprising:
a memory; and
a processor configured to perform the method of claim 2.
